(19) United States
(12) Patent Application Publication
(10) Pub. No.: US 2009/0126968 A1
(43) Pub. Date: May 21, 2009

(54) Screwless wall-plate

(76) Inventor: Barry Glas, Carmel, IN (US)

Correspondence Address: Linda L. Vitone, 334 N. Senate Avenue, Indianapolis, IN, 46204, US

(21) Appl. No.: 11/985,882

(22) Filed: Nov. 19, 2007

(51) Int. Cl. H02G 3/14

(52) U.S. Cl. 174/66

(57) ABSTRACT

The present invention provides for a screwless wall-plate assembly which includes a base plate component, at least two barbed fastener components, and a face plate component irremovably attached to the base plate component. The base plate component has a central opening for receiving at least one electrical component and at least two openings to receive the fastener components. The fastener component is fitted through the base plate and is sized to mate with the openings in a standard yoke or mounting strap electrical device. The face plate component has at least one opening configured to accommodate a gang device body and is permanently affixed to the front of the base plate. Once the screwless wall-plate is fully assembled, the fasteners provide secure yet removable means of affixing the screwless wall-plate to a standard yoke or strap mounting electrical device, thereby completing enclosure of the wired device inside the electrical box.

### CROSS REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention is generally directed to the field of electrical wiring components and wall-mounted enclosures or boxes for electrical wiring devices, such as switches, electrical outlets, dimmers, actuators, and data ports, and more specifically to a screwless wall-plate assembly for use in conjunction with such wall-mounted enclosures or boxes.

### BACKGROUND OF THE INVENTION

Conventional cover plates for wall-mounted electrical wiring enclosures or electrical wiring boxes, referred to herein as “wall-plates,” are usually constructed in the form of a flat plastic or metal plated having one or more opening to provide limited access to a wired device within the enclosure. A “wired device” as used herein refers to any number of electrical power/signal control or distribution devices, including, but not limited to switches, electrical outlets, dimmers, actuators, cable connectors, phone jacks, and data ports. The purpose of the wall-plate is to provide a decorative cover for the electrical box while preventing the operator exposure to electrical terminals and wiring within the interior of the electrical box.

Wired devices conforming to the National Electrical Manufacturers Association (NEMA) standards include a metal yoke or mounting strap (collectively, referred to as a “yoke”) with oversized mounting holes which permit adjustment of the wired device within the electrical box. The yoke also includes one or more threaded mounting holes for attaching a wall-plate by means of screw or screw-type fasteners onto the yoke, thereby completing enclosure of the wired device inside the electrical box. Therefore, traditionally wall-plates have been mounted onto the yoke of a wired device by standard screw fasteners.

While screw-type wall-plates offer the operator ready access to the wired device in the electrical box in the event that repair or replacement of the wired device is necessary, screw-type wall-plates are often less aesthetically pleasing to consumers than screwless wall-plates. Attempts to make screw-type wall-plates more pleasing to consumers, such as painting or otherwise covering the screws, are fraught with various problems. U.S. Pat. No. 5,189,259 (the “'529 Patent”), incorporated herein by reference to the fullest extent allowed, discusses the problems associated with screw-type wall-plates.

In light of the problems associated with screw-type wall-plates and the desire of consumers to have aesthetically pleasing wall-plates which match their decor, a number of screwless wall-plates, including, but not limited to the screwless wall-plate disclosed in the 529 Patent, have been developed. The screwless wall-plates available to date generally require the installation of non-standard electrical boxes or wired devices designed to mate with the screwless wall-plate or require the addition of an intermediate plate designed to attach by means of screw fasteners to the yoke of any standard NEMA wired device, and thus require the purchase and installation of specialized electrical boxes or additional hardware to attach the screwless wall-plate.

### BRIEF SUMMARY OF THE INVENTION

The present invention provides for a one piece screwless wall-plate assembly which can be attached directly to the yoke of a standard NEMA wired device thereby eliminating the need to purchase and install specialized electrical boxes and/or additional mounting hardware as required in conjunction with the screwless wall-plate designs currently available in the market place. Further, the fastening mechanism utilized in the one piece wall-plate assembly attaches securely enough to the yoke to allow for the wall-plate to be made from a wide variety of materials including, but not limited to glass, ceramic, wood, and stainless steel, which provides consumers with an aesthetically pleasing wall-plate to match their decor. Additionally, the wall-plate can be readily removed from and reattached to the yoke to allow the operator ready access to the wired device in the electrical box in the event that repair or replacement of the wired device is necessary.

The preferred embodiment of the invention is a screwless wall-plate assembly comprised of a sub-plate with ridged sides permanently affixed to a base plate composed of polycarbonate by means of over-mold process, at least two barbed nylon fasters, and a face plate permanently affixed to the base plate. The base plate has a central opening for receiving an N-gang body device, where N is an integer from 1 to 8, and has recessed or counter-set openings to receive the fasteners. The number of recessed or counter-set openings, arranged in pairs on opposite sides of the central opening in the base plate, is equal to two (2) times N. The distance between each pair recessed or counter-set openings as measured from the center of each opening is approximately 98.4 millimeters.

Each fastener consists of a nylon retainer with a shaft having a longitudinal axis, a head formed on a first end of the shaft, a plurality of fins extending radially from the shaft and disposed on the shaft at a predetermined longitudinal spacing from each other, and an end piece formed on a second end of the shaft. Each fastener is fitted through the front of the base plate component, so that the head of the fastener is flush with the top of the base plate and the fastener shaft extends rearward from the back of the base plate. The fastener shaft is sized to mate with the openings in a standard yoke electrical device. A commercial adhesive, such as 3M brand double-sided adhesive tape, is placed into each recessed or counter-set hole in the base plate before inserting the fasteners into the base plate. Once the screwless wall-plate is fully assembled, the fasteners provide secure yet removable means of affixing the screwless wall-plate to a standard yoke electrical device, thereby completing enclosure of the wired device inside the electrical box.

The face plate is made of glass, ceramic, granite, or marble and has at least one opening configured to accommodate an N-gang device body. For a standard N-gang body device the opening in the face plate is 67.4 millimeters high by 33.9 millimeters wide creating a close, conforming fit around the gang body device thereby concealing the yoke, wiring, and electrical box. The number of openings in the face plate is equal to N. The glass face plate is polished and beveled on the top, bottom, and sides for the safety of the consumer and to provide a clean finished look that is aesthetically pleasing to the consumer. The face plate is permanently affixed to the front of the base plate using commercially available double sided adhesive tape, such as 3M brand double-sided adhesive tape.

Another embodiment of the invention is directed to a screwless wall-plate assembly wherein the face plate is made of stainless steel, chrome, brass, or other metal.

Another embodiment of the invention is directed to a screwless wall-plate assembly wherein the face plate is made of wood.

### BRIEF DESCRIPTION OF THE SEVERAL VIEWS OF THE DRAWINGS

FIG. 1 is an exploded view of the preferred embodiment of the wall plate for an N-gang body device, wherein N is 1, having a glass face plate showing the component parts and fasteners.

FIG. 2 is a perspective view of the preferred embodiment of the wall plate for an N-gang body device, wherein N is 1, having a glass face plate.

FIG. 3 is a side view of the preferred embodiment of the wall plate for an N-gang body device, wherein N is 1, having a glass face plate.

FIG. 4 is a back view of the preferred embodiment of the wall plate for an N-gang body device, wherein N is 1, having a glass face plate.

FIG. 5 is a cross-sectional view of the preferred embodiment of the wall plate for an N-gang body device, wherein N is 1, having a glass face plate along the lines A to A.

FIG. 6 is a front view of the preferred embodiment of the sub-plate.

FIG. 7 is a side view of the preferred embodiment of the sub-plate.

FIG. 8 is a cross-sectional view of the preferred embodiment of the sub-plate along the lines B to B.

FIG. 9 is an exploded side view of the preferred embodiment of the sub-plate.

FIG. 10 is a front view of the preferred embodiment of the base plate for an N-gang body device, wherein N is 1.

FIG. 11 is a side view of the preferred embodiment of the base plate for an N-gang body device, wherein N is 1.

FIG. 12 is a back view of the preferred embodiment of the base plate for an N-gang body device, wherein N is 1.

FIG. 13 is a perspective view of the preferred embodiment of the base plate for an N-gang body device, wherein N is 1.

FIG. 14 is a perspective view of the sub-plate attached to the base plate for an N-gang body device, wherein N is 1.

FIG. 15 is an expanded side view of the preferred embodiment of the fasteners.

FIG. 16 is a top view of the fasteners.

FIG. 17 is a front view of the fasteners fitted to and mated with the base plate and sub-plate assembly, for an N-gang body device, wherein N is 1.

FIG. 18 is a side view of the fasteners fitted to and mated with the base plate and sub-plate assembly, for an N-gang body device, wherein N is 1.

FIG. 19 is a side cross-sectional view of the fasteners fitted to and mated with the base plate and sub-plate assembly, for an N-gang body device, wherein N is 1, along the lines C to C.

FIG. 20 is a perspective view of the fasteners fitted to and mated with the base plate and sub-plate assembly, for an N-gang body device, wherein N is 1.

FIG. 21 is a front view of the preferred embodiment of a glass face plate for an N-gang body device, wherein N is 1.

FIG. 22 is a side view of the preferred embodiment of a glass face plate for an N-gang body device, wherein N is 1.

FIG. 23 is a perspective view of the preferred embodiment of a glass face plate for an N-gang body device, wherein N is 1.

FIG. 24 is a perspective view of the preferred embodiment of the base plate for an N-gang body device, wherein N is 2.

FIG. 25 is a perspective view of the preferred embodiment of a glass face plate for an N-gang body device, wherein N is 2.

FIG. 26 is a perspective view of the preferred embodiment of the base plate for an N-gang body device, wherein N is 3.

FIG. 27 is a front view of the preferred embodiment of a glass face plate for an N-gang body device, wherein N is 3.

FIG. 28 is a perspective view of the preferred embodiment of the base plate for an N-gang body device, wherein N is 4.

FIG. 29 is a front view of the preferred embodiment of a glass face plate for an N-gang body device, wherein N is 4.

FIG. 30 is a front view of the preferred embodiment of a metal face plate for an N-gang body device, wherein N is 1.

FIG. 31 is a side view of the preferred embodiment of a metal face plate for an N-gang body device, wherein N is 1.

FIG. 32 is a perspective view of the preferred embodiment of a metal face plate for an N-gang body device, wherein N is 1.

FIG. 33 is a front view of the preferred embodiment of a wood face plate for an N-gang body device, wherein N is 1.

FIG. 34 is a side view of the preferred embodiment of a wood face plate for an N-gang body device, wherein N is 1.

FIG. 35 is a perspective view of the preferred embodiment of a wood face plate for an N-gang body device, wherein N is 1.

### DETAILED DESCRIPTION OF THE INVENTION

The present invention provides a screwless wall-plate assembly which is characterized by its aesthetically appealing appearance and versatility. The wall-plate assembly is attached to the yoke of any standard NEMA wired device utilizing barbed fasteners which are press-fit into the openings on the yoke, thereby completing enclosure of the wired device inside the electrical box without the use of unsightly screws, or the need to purchase and/or install an intermediate plate or additional hardware. The wall-plate assembly can be removed and reattached as needed to gain access to the wired devise in the event that repair or replacement of the wired device is necessary, or if the consumer changes decor and merely wishes to change the wall-plate assembly to match such decor.

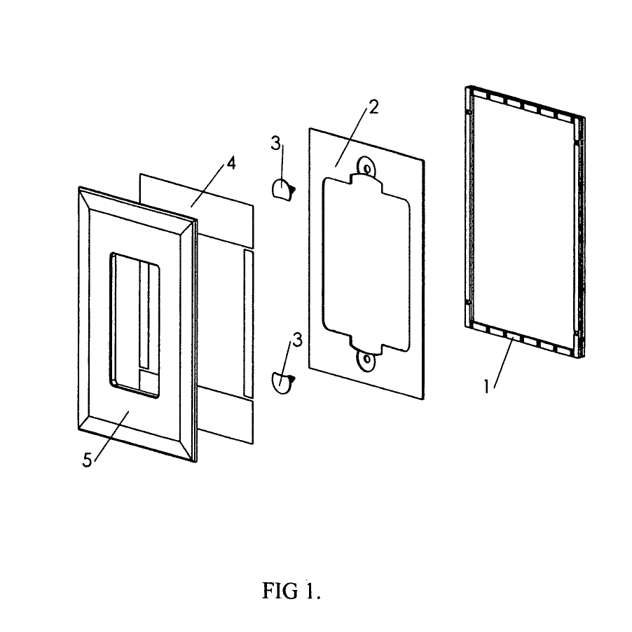

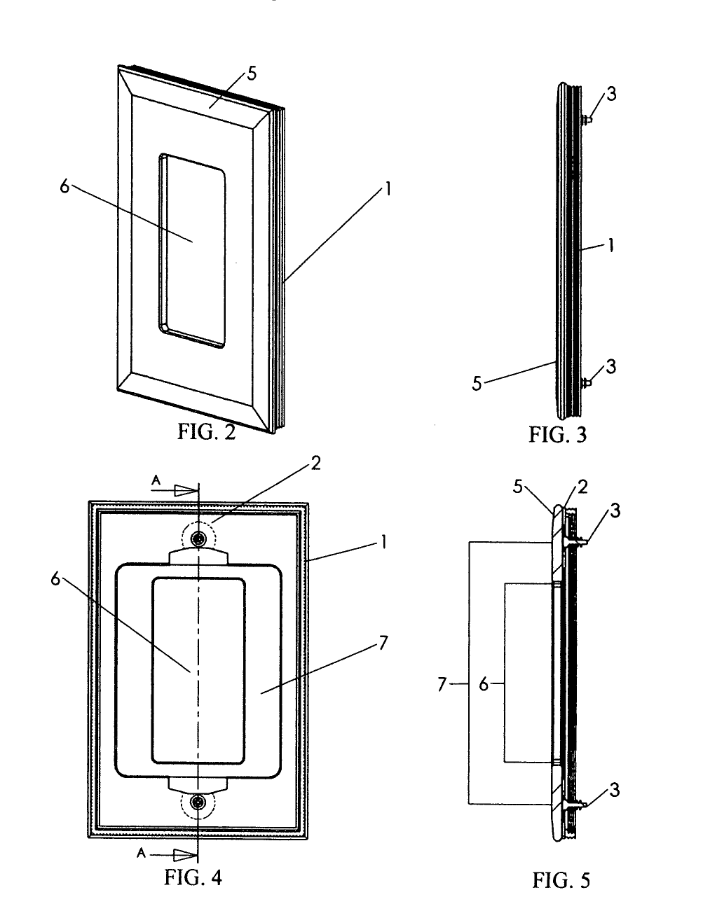

FIGS. 1-5 show the preferred embodiment of the screwless wall-plate assembly for a 1-gang device body having a glass face plate. The screwless wall-plate assembly of the present invention includes a sub-plate 1, a base plate 2, at least two (2) fasteners 3 which are fitted through and extending rearward from the base plate and used to connect the wall-plate assembly to the yoke of a standard NEMA wired device, a face plate 5, and a means of attaching 4 the base plate to the face plate. The wall-plate assembly has at least one opening in the face plate 6 to accommodate a gang body device and which is sized for a close, conforming fit around the gang body device thereby concealing the yoke, wiring, and electrical box.

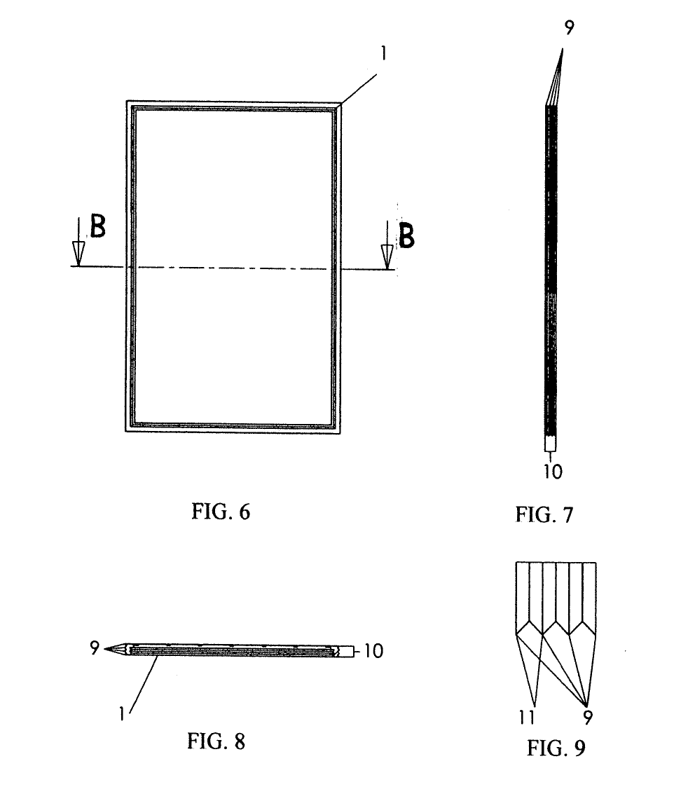

The sub-plate, as shown in FIGS. 6-9 for a 1-gang device body, is made of silicone and is configured as a frame having an outer perimeter defined by outer opposing surfaces, such outer surfaces being primarily the inner perimeter of a recess or hole cut into a wall or other covering for the purpose of obtaining access to an electrical box mounted inside such wall. The width of the sub-plate frame 8 is between 2.5 to 4.5 millimeters and the depth of the sub-plate 10 is 2.0 to 5.0 millimeters. All four sides of the sub-plate contain a series of ridges 9 set at an angle 11 of 90 degrees to one another which allow the outer edge of the sub-plate component to compress creating a close, conforming fit to the outer opposing surfaces.

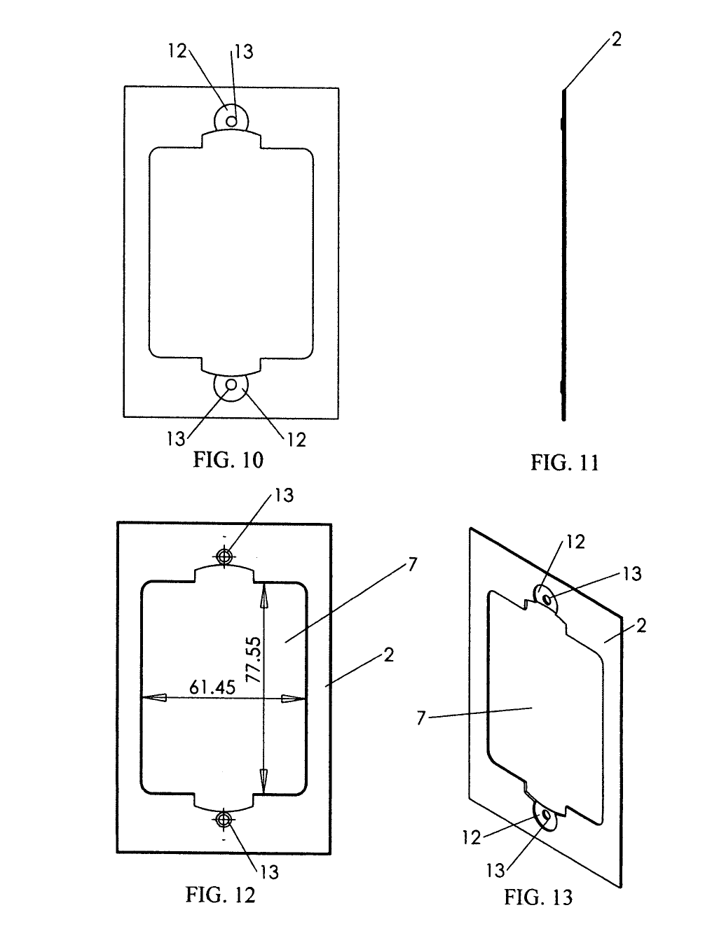

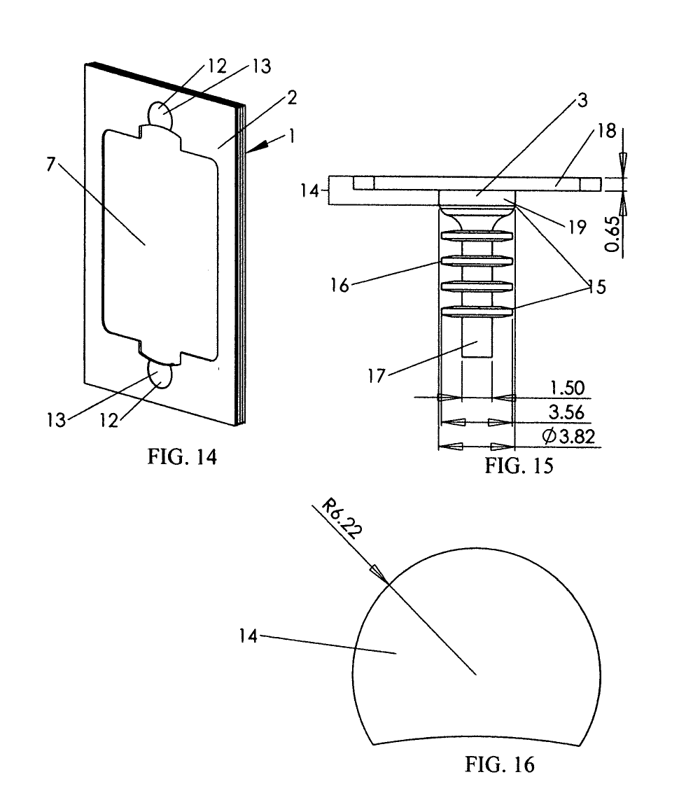

Referring to FIGS. 10-14 for a 1-gang device body, the base plate 2 is made of polycarbonate and comprises a single component configured as a frame. The outer perimeter of the base plate is equal to the outer perimeter of the sub-plate. The inner perimeter or central opening of the frame 7 is configured to accommodate a 1-gang device body. For a 1-gang device body, the base plate 2 has two (2) openings 12 recessed or counter-set into the base plate to receive the fastener component. The radius of the opening is equal to the radius of the fastener head 14, shown in FIG. 16, and the depth of the opening is equal to the width of the top portion of the fastener head 18, as shown in FIG. 15. At the center of each recessed opening is a round aperture 13 with a diameter equal to the diameter of the fastener fins 16, shown in FIG. 15. The apertures 13 are configured to align with the openings in a yoke or mounting strap electrical device, and as such, the distance between the center-point of each aperture is 96.8 millimeters. The sub-plate 1 is over-molded to the base plate 2, as shown in FIG. 14.

Referring to FIGS. 15-16, the fastener component includes a head 14 disposed at the top of a shaft 15, an end piece 17, and a plurality of fins 16 extending radially outward from the shaft. The head 14 is generally circular in shape with a flat upper section 18 equal in diameter to the diameter of the recessed or counter-set openings 12 in the base plate 2 and a lower circular section 19 equal in diameter to the diameter of the round aperture 13 in the base plate 2. The fins 16 are disposed on the shaft 15 at a predetermined longitudinal spacing from each other. The diameter of the fins is equal to the diameter of the aperture 13 in the base plate 2.

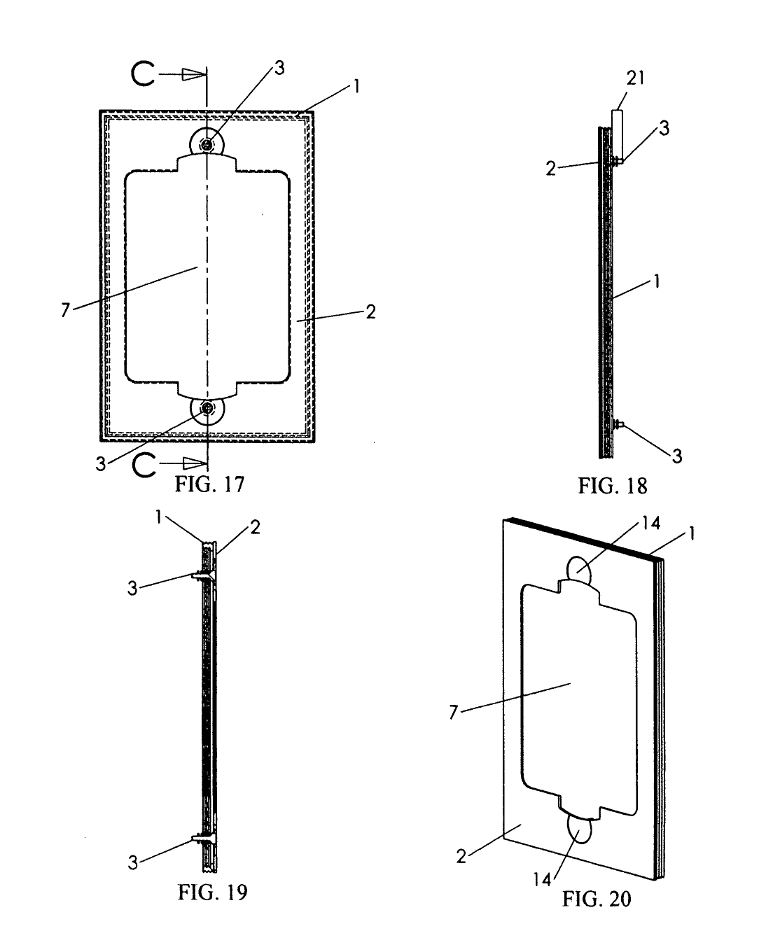

To securely attach the fasteners 3 to the base plate 2, a small amount of commercial adhesive, such as 3M brand liquid adhesive, is placed in the recessed or counter-set openings 12 in the base plate 2. The fasteners 3 are then the fitted through the apertures 13 in the base plate 2 so that the head of the fastener 14 is flush with the top of the base plate 2, as shown in FIGS. 17, 18, 19 and 20. The fastener 3 extends rearward through the base plate 2 and extends a distance 21 of at least 7.5 millimeters beyond the back 20 of the base plate 1, as shown in FIG. 18.

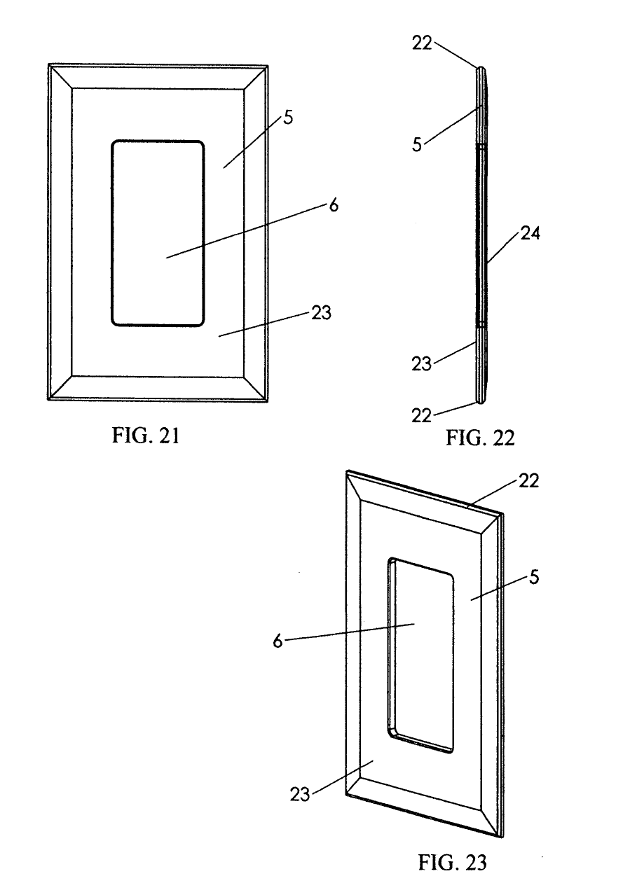

FIGS. 21, 22, and 23, show the preferred embodiment of a glass face plate 5 of the screwless wall-plate assembly for a 1-gang device body. The glass face plate 5 has one (1) opening 6 measuring 67.4 millimeters high by 33.9 millimeters wide configured to accommodate the 1-gang device body, thereby creating a close, conforming fit around the gang body device in the fully assembled wall-plate. The glass face plate 5 is polished and beveled on the top 23, bottom 24, and sides 24 for the safety of the consumer and to provide a clean finished look that is aesthetically pleasing to the consumer.

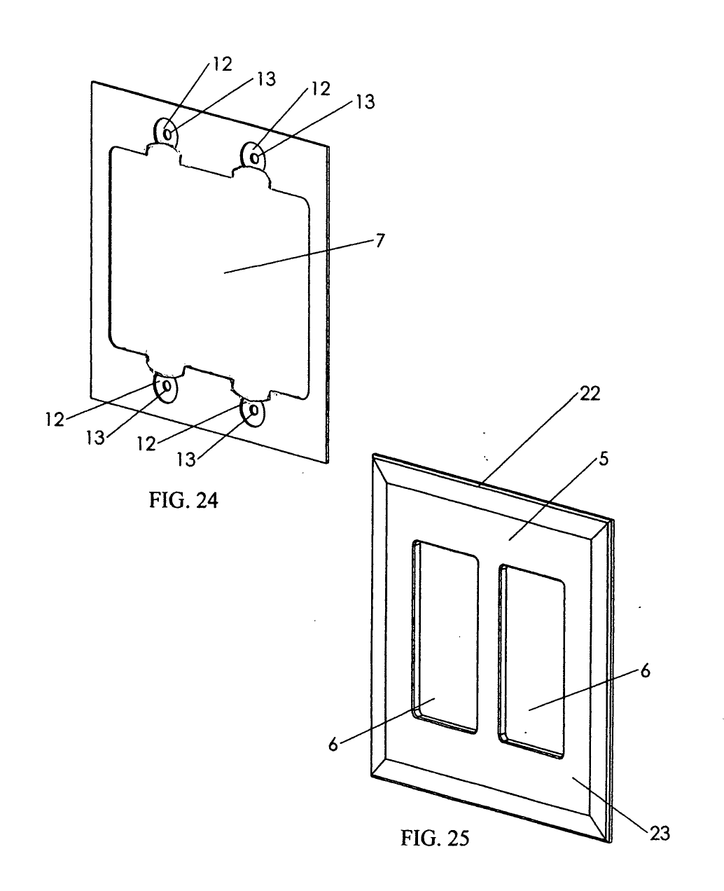

FIG. 24 shows the configuration of a base plate 2 for a 2-gang device body. For a 2-gang device body, the base plate 2 has four (4) openings 12 recessed or counter-set into the base plate to receive the fastener component. Four (4) recessed or counter-set openings 12 to receive the fastener component and four (4) corresponding apertures 13 are depicted. The apertures 13 are configured to align with the openings in a yoke or mounting strap for a 2-gang device body, and as such, the distance between the center-point of each aperture is 96.8 millimeters.

FIG. 25 shows the configuration of a glass face plate 2 for a 2-gang device body. The glass face plate 5 has two (2) openings 6 measuring 67.4 millimeters high by 33.9 millimeters wide configured to accommodate the 2-gang device body, thereby creating a close, conforming fit around the gang body device in the fully assembled wall-plate. The glass face plate 5 is polished and beveled on the top 23, bottom 24, and sides 24 for the safety of the consumer and to provide a clean finished look that is aesthetically pleasing to the consumer.

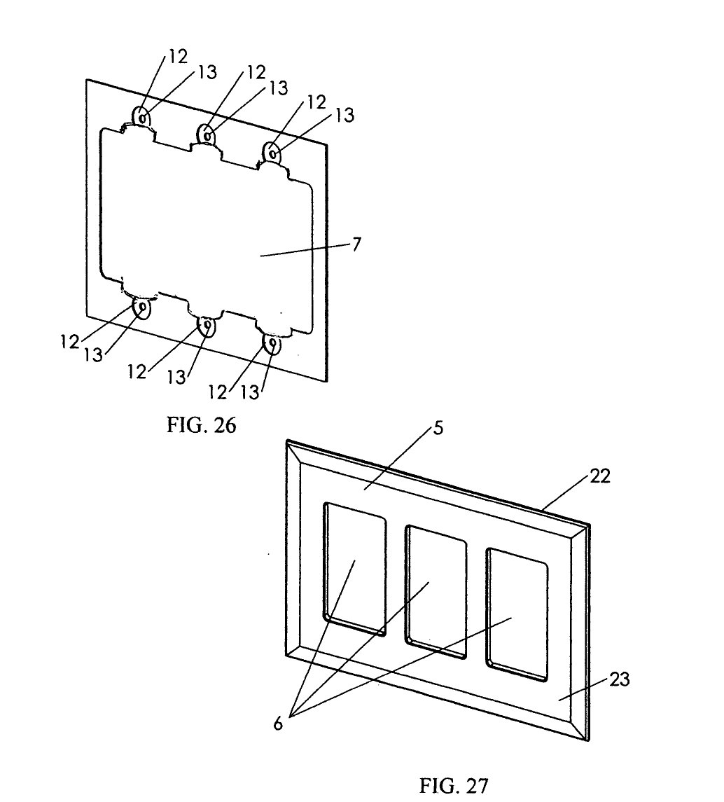

FIG. 26 shows the configuration of a base plate 2 for a 3-gang device body. For a 3-gang device body, the base plate 2 has six (6) openings 12 recessed or counter-set into the base plate to receive the fastener component. Six (6) recessed or counter-set openings 12 to receive the fastener component and six (6) corresponding apertures 13 are depicted. The apertures 13 are configured to align with the openings in a yoke or mounting strap for a 3-gang device body, and as such, the distance between the center-point of each aperture is 98.4 millimeters.

FIG. 27 shows the configuration of a glass face plate 2 for a 3-gang device body. The glass face plate 5 has three (3) openings 6 measuring 67.4 millimeters high by 33.86 millimeters wide configured to accommodate the 3-gang device body, thereby creating a close, conforming fit around the gang body device in the fully assembled wall-plate. The glass face plate 5 is polished and beveled on the top 23, bottom 24, and sides 24 for the safety of the consumer and to provide a clean finished look that is aesthetically pleasing to the consumer.

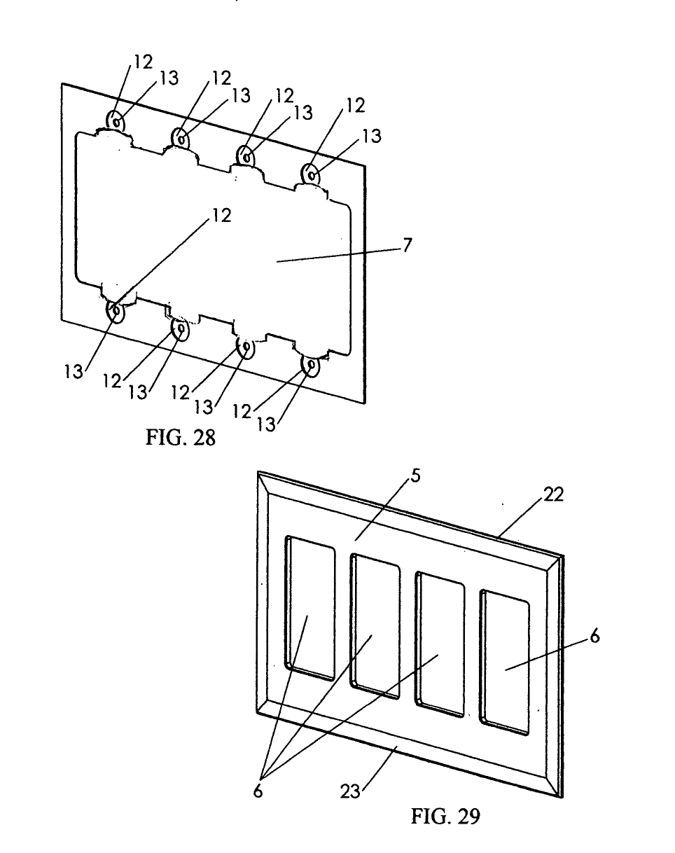

FIG. 28 shows the configuration of a base plate 2 for a 4-gang device body. For a 4-gang device body, the base plate 2 has eight (8) openings 12 recessed or counter-set into the base plate to receive the fastener component. Eight (8) recessed or counter-set openings 12 to receive the fastener component and eight (8) corresponding apertures 13 are depicted. The apertures 13 are configured to align with the openings in a yoke or mounting strap for a 4-gang device body, and as such, the distance between the center-point of each aperture is 98.4 millimeters.

FIG. 29 shows the configuration of a glass face plate 2 for a 4-gang device body. The glass face plate 5 has four (4) openings 6 measuring 67.4 millimeters high by 33.86 millimeters wide configured to accommodate the 4-gang device body, thereby creating a close, conforming fit around the gang body device in the fully assembled wall-plate. The glass face plate 5 is polished and beveled on the top 23, bottom 24, and sides 24 for the safety of the consumer and to provide a clean finished look that is aesthetically pleasing to the consumer.

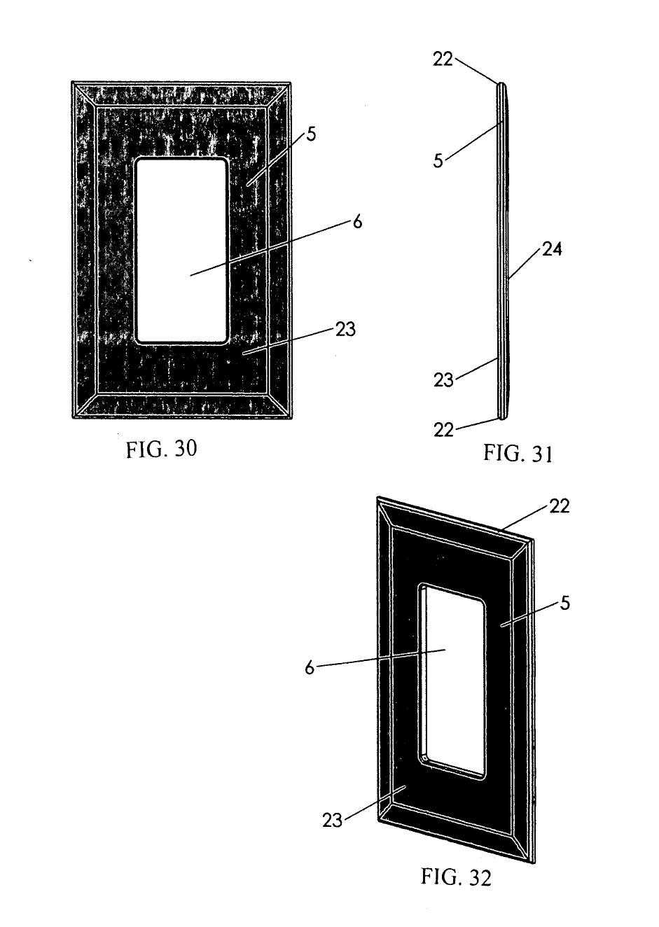

FIGS. 30, 31, and 32, show the preferred embodiment of a metal face plate 5 of the screwless wall-plate assembly for a 1-gang device body. The metal face plate 5 has one (1) opening 6 measuring 67.4 millimeters high by 33.9 millimeters wide configured to accommodate the 1-gang device body, thereby creating a close, conforming fit around the gang body device in the fully assembled wall-plate. The metal face plate 5 is beveled on the top 23, bottom 24, and sides 24 to provide a clean finished look that is aesthetically pleasing to the consumer.

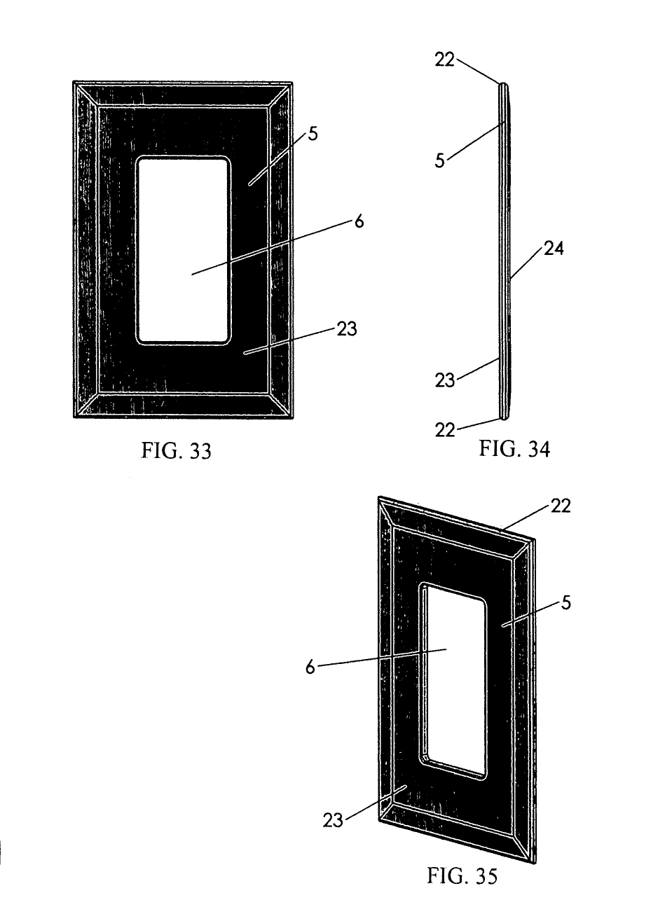

FIGS. 33, 34, and 35, show the preferred embodiment of a wooden face plate 5 of the screwless wall-plate assembly for a 1-gang device body. The wooden face plate 5 has one (1) opening 6 measuring 67.4 millimeters high by 33.9 millimeters wide configured to accommodate the 1-gang device body, thereby creating a close, conforming fit around the gang body device in the fully assembled wall-plate. The wooden face plate 5 is beveled on the top 23, bottom 24, and sides 24 to provide a clean finished look that is aesthetically pleasing to the consumer.

What is claimed:

1. A screwless wall-plate assembly comprising:
a sub-plate component that comprises: a single component configured as a frame having an outer perimeter defined by outer opposing surfaces and an inner perimeter 2.0 to 6.0 millimeters less than the outer perimeter, having ridged sides 2.0 to 10.0 millimeters in depth, and over-molded to the back of the base plate;
a base plate that comprises: a single component configured as a frame, the outer perimeter of the component equal to the outer perimeter of the sub-plate component and the inner perimeter configured to accommodate an N-gang device body, where N is an integer value, and at least two (2) openings recessed or counter-set into the base plate component fitted to receive the fastener component and configured to align and mate with the openings in a standard yoke or mounting strap electrical device;
at least two (2) fasteners fitted through and mated flush with the front surface of the base plate and extending rearward from the back of the base plate at least 7.5 millimeters beyond the base plate; and
a face plate that comprises: a single component having an outer perimeter slightly larger than the base plate, having at least one opening configured to accommodate N-gang device body, and a means of permanently attaching the back side of the face plate to the front surface of the base plate, wherein the attaching means consists of an adhesive tape.

2. A screwless wall-plate assembly of claim 1 wherein the fasteners comprise: a shaft having a longitudinal axis, a head formed on a first end of the shaft, a plurality of fins extending radially from the shaft and disposed on the shaft at a predetermined longitudinal spacing from each other, and an end piece with a generally cylindrical shape formed on a second end of the shaft.

3. A screwless wall-plate assembly of claim 1 wherein the face plate component is made of glass, ceramic, granite, or marble.

4. A screwless wall-plate assembly of claim 1 wherein the face plate component is made of stainless steel, chrome, brass, bronze, nickel, or other metal.

5. A screwless wall-plate assembly of claim 1 wherein the face plate component is made of wood.

6. A screwless wall-plate assembly of claim 1 wherein the base plate component is made of polycarbonate, plastic, or a similar synthetic polymeric material.

7. A screwless wall-plate assembly of claim 1 wherein the sub-plate component is made of silicone or a similar synthetic polymeric material.

8. A screwless wall-plate assembly of claim 1 wherein the fasteners are made of nylon or a similar synthetic polymeric material.

9. A base plate component of claim 1 wherein N is any integer from one (1) to eight (8).

10. A face plate component of claim 1 wherein N is any integer from one (1) to eight (8).

11. A screwless wall-plate assembly of claim 2 wherein the face plate component is made of glass, ceramic, granite, or marble.

12. A screwless wall-plate assembly of claim 2 wherein the face plate component is made of stainless steel, chrome, brass, bronze, nickel, or other metal.

13. A screwless wall-plate assembly of claim 2 wherein the face plate component is made of wood.

14. A screwless wall-plate assembly of claim 2 wherein the base plate component is made of polycarbonate, plastic, or a similar synthetic polymeric material.

15. A screwless wall-plate assembly of claim 2 wherein the sub-plate component is made of silicone or a similar synthetic polymeric material.

16. A base plate component of claim 2 wherein N is any integer from one (1) to eight (8).

17. A face plate component of claim 2 wherein N is any integer from one (1) to eight (8).

18. A screwless wall-plate assembly of claim 2 wherein the fasteners are made of nylon or a similar synthetic polymeric material.

19. A screwless wall-plate assembly of claim 18 wherein the face plate component is made of glass, ceramic, granite, or marble.

20. A screwless wall-plate assembly of claim 18 wherein the face plate component is made of stainless steel, chrome, brass, or other metal.

21. A screwless wall-plate assembly of claim 18 wherein the face plate component is made of wood.

22. A screwless wall-plate assembly of claim 18 wherein the base plate component is made of polycarbonate, plastic, or a similar synthetic polymeric material.

23. A screwless wall-plate assembly of claim 18 wherein the sub-plate component is made of silicone or a similar synthetic polymeric material.

24. A base plate component of claim 18 wherein N is any integer from one (1) to eight (8).

25. A face plate component of claim 18 wherein N is any integer from one (1) to eight (8).
